(19) United States
(12) Patent Application Publication
(10) Pub. No.: US 2012/0312787 A1
(43) Pub. Date: Dec. 13, 2012

(54) ELECTRICAL DISCHARGE MACHINING APPARATUS AND ELECTRICAL DISCHARGE MACHINING METHOD

(75) Inventors: Takayuki Nakagawa, Tokyo (JP); Tatsushi Sato, Tokyo (JP); Hidetaka Miyake, Tokyo (JP); Takashi Yuzawa, Tokyo (JP); Atsushi Itokazu, Tokyo (JP)

(73) Assignee: Mitsubishi Electric Corporation, Tokyo (JP)

(21) Appl. No.: 13/579,970

(22) PCT Filed: Mar. 29, 2011
(86) PCT No.: PCT/JP11/57841

§ 371 Date: Aug. 20, 2012

(30) Foreign Application Priority Data
Apr. 9, 2010 (JP) 2010-090902

(51) Int. Cl. B23H 7/02; B23H 7/10

(52) U.S. Cl. 219/69.12

(57) ABSTRACT

An electrical discharge machining apparatus includes a machining electrode that is one wire and includes a plurality of opposing sections with respect to a workpiece by being wound around a plurality of guide rollers, driving units that change a relative distance between the workpiece and the opposing sections, and a plurality of pulse generating units that apply electrical discharge machining pulses between the workpiece and the opposing sections, respectively, in which the pulse generating units are controlled such that application start times of electrical discharge machining pulses for adjacent opposing sections do not coincide with each other.

### FIELD

The present invention relates to an electrical discharge machining apparatus that removes or cuts a part of a workpiece at a plurality of locations at the same time by generating electrical discharge between the workpiece and a machining electrode opposed to the workpiece at a plurality of locations, and also relates to an electrical discharge machining method.

### BACKGROUND

In a conventional electrical discharge machining apparatus, electrical discharge machining pulses are applied between a workpiece and each of a plurality of machining electrodes, which are opposed to the workpiece and are not electrically connected to each other, thereby performing electrical discharge machining at the same time (for example, Patent Literature 1). Moreover, when performing electrical discharge machining by causing one machining electrode to oppose to a workpiece at a plurality of locations, the impedance with the adjacent opposing section of the machining electrode is increased by increasing the distance from the adjacent machining electrode or coiling the machining electrode (for example, Patent Literature 2).

### CITATION LIST

### Patent Literature

Patent Literature 1: Japanese Patent Application Laid-open No. H09-248719

Patent Literature 2: Japanese Patent Application Laid-open No. 2000-107941

### SUMMARY

### Technical Problem

However, because the above-described conventional electrical discharge machining apparatus is composed of a plurality of machining electrodes that are not electrically connected to each other, a machining electrode running system becomes complicated, therefore, it is difficult to realize multiple-parallel (for example, equal to or more than 10 in parallel) and narrow-gap (for example, 1 mm or less) machining.

Moreover, in a system in which one machining electrode is opposed to a workpiece at a plurality of locations and a section between the machining electrode and an adjacent machining electrode is coiled, space needs to be reserved for coiling the section, therefore, it is difficult to realize multiple parallel (for example, equal to or more than 10 in parallel) and narrow gap (for example, 1 mm or less). Moreover, in these systems, a machining preparation process for routing the machining electrode becomes complicated. Furthermore, the apparatus becomes larger as the parallel number becomes larger.

This invention is achieved in view of the above and has an object to avoid disconnection of the machining electrode and degradation of the quality of the machined surface by suppressing short-circuit current and to obtain a multiple-parallel and narrow-gap electrical discharge machining apparatus. Moreover, this invention has an object to shorten a machining preparation process and reduce the size of the apparatus.

### Solution to Problem

In order to solve the aforementioned problems, an electrical discharge machining apparatus according to one aspect of the present invention is configured to include: a machining electrode that is one wire and includes a plurality of opposing sections with respect to a workpiece by being wound around a plurality of guide rollers; a driving unit that changes a relative distance between the workpiece and the opposing sections; and a plurality of pulse generating units that apply electrical discharge machining pulses between the workpiece and the opposing sections, respectively, wherein the pulse generating units are controlled such that application start times of electrical discharge machining pulses for adjacent opposing sections do not coincide with each other.

### Advantageous Effects of Invention

According to the present invention, abnormal consumption and disconnection of the machining electrode and degradation of the quality of the machined surface can be avoided by suppressing the concentration of the electrical discharge machining current, which flows largely immediately after the start of the application of an electrical discharge machining pulse, in a short-circuited portion. Moreover, abnormal consumption and disconnection of the machining electrode and degradation of the quality of the machined surface can be prevented while maintaining the machining speed regardless of the rate of the application time or the pause time of electrical discharge machining pulses. Moreover, because the gaps can be narrowed, the apparatus can be reduced in size. Furthermore, an effect is obtained in which the preparation process before the start of the machining is shortened.

### BRIEF DESCRIPTION OF DRAWINGS

FIG. 1 is a schematic diagram of a main part of an electrical discharge machining apparatus according to a first embodiment of the present invention.

FIG. 2 is an equivalent circuit diagram of a machining electrode opposed to a workpiece at a plurality of locations in the electrical discharge machining apparatus according to the first embodiment of the present invention.

FIG. 3 is a circuit diagram illustrating a configuration of an electrical-discharge-machining-pulse generating unit of the electrical discharge machining apparatus according to the first embodiment of the present invention.

FIG. 4 is a diagram illustrating an electrical discharge machining pulse pattern of the electrical discharge machining apparatus according to the first embodiment of the present invention.

FIG. 5 is a diagram illustrating discharge current waveforms at a time of a normal machining in the electrical discharge machining apparatus according to the first embodiment of the present invention.

FIG. 6 is a diagram illustrating discharge current waveforms when part of the electrical discharge machining apparatus according to the first embodiment of the present invention is short-circuited.

FIG. 7 is a circuit diagram illustrating a configuration of an electrical-discharge-machining-pulse generating unit of an electrical discharge machining apparatus according to a second embodiment of the present invention.

FIG. 8 is a diagram illustrating an electrical discharge machining pulse pattern of the electrical discharge machining apparatus according to the second embodiment of the present invention.

FIG. 9 is a diagram illustrating discharge current waveforms when part of the electrical discharge machining apparatus according to the second embodiment of the present invention is short-circuited.

FIG. 10 is a schematic diagram of a main part of an electrical discharge machining apparatus according to a third embodiment of the present invention.

FIG. 11 is a diagram illustrating an electrical discharge machining pulse pattern of the electrical discharge machining apparatus according to the third embodiment of the present invention.

FIG. 12 is a flowchart for determining an electrical discharge machining pulse pattern of an electrical discharge machining apparatus according to a fourth embodiment of the present invention.

### DESCRIPTION OF EMBODIMENTS

Exemplary embodiments of an electrical discharge machining apparatus according to the present invention will be explained below in detail based on the drawings. This invention is not limited to these embodiments.

### First Embodiment

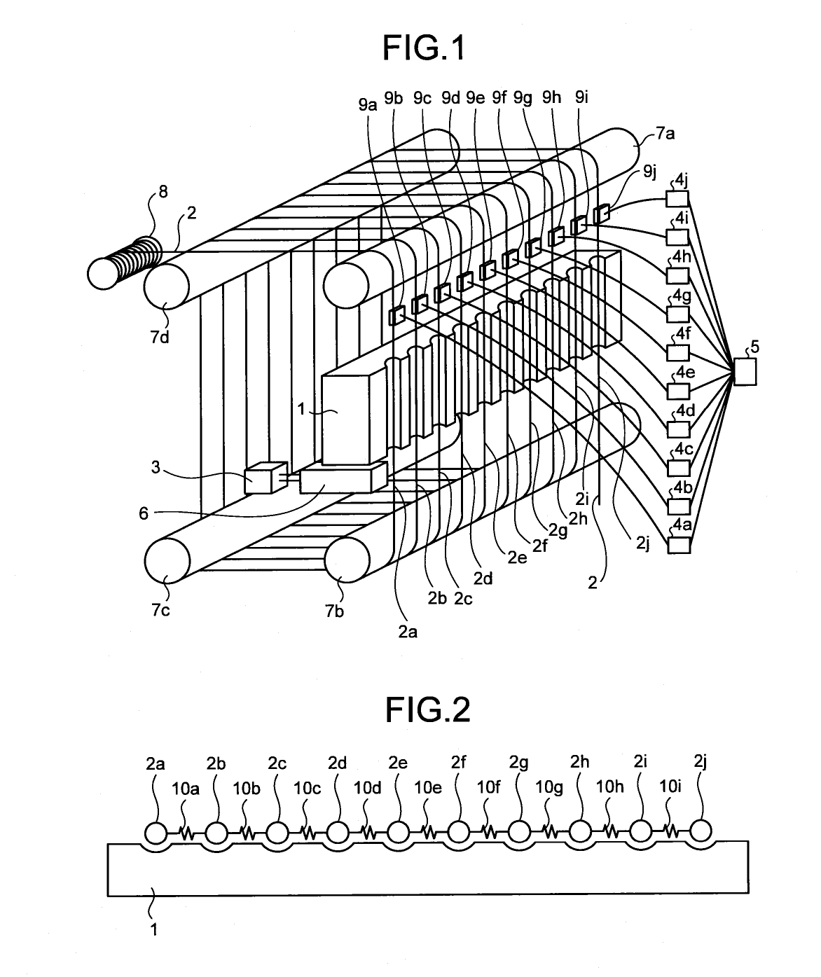

FIG. 1 is a schematic diagram illustrating a main part of an electrical discharge machining apparatus according to the first embodiment of the present invention. A machining electrode 2, which is composed of one wire paid out from a machining electrode bobbin 8, is wound around guide rollers 7a to 7d in the order of the guide rollers 7a, 7b, 7c, 7d, 7a, 7b, 7c, 7d, . . . . The machining electrode 2 and a workpiece 1 (work) are opposed to each other in a machining fluid (for example, deionized water) (not shown) at ten locations corresponding to opposing sections 2a, 2b, 2c, 2d, 2e, 2f, 2g, 2h, 2i, and 2j, which are a plurality of parallel wires formed by the wound machining electrode 2. The opposing sections 2a to 2j are provided at ten locations as an example, however, the number thereof is not limited thereto.

The workpiece 1 is fixed to a driving table 6 and the relative distance between the opposing sections 2a to 2j of the machining electrode 2 and the workpiece 1 can be changed by driving the driving table 6 by a motor 3. A pulse control unit 5 transmits a control signal that causes pulse generating units 4a, 4b, 4c, 4d, 4e, 4f, 4g, 4h, 4i, and 4j to generate an electrical discharge machining pulse. Electrical discharge machining pulses generated in the pulse generating units 4a to 4j are fed to the opposing sections 2a to 2j of the machining electrode 2 via power feed contacts 9a, 9b, 9c, 9d, 9e, 9f, 9g, 9h, 9i, and 9j, respectively.

FIG. 2 is an equivalent circuit diagram of the machining electrode opposed to the workpiece at a plurality of locations in the electrical discharge machining apparatus according to the first embodiment of the present invention. Resistors 10a, 10b, 10c, 10d, 10e, 10f, 10g, 10h, and 10i indicate equivalent resistance (for example, 100Ω or less) between the opposing sections of each machining electrode.

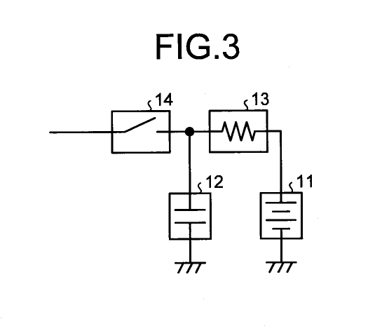

FIG. 3 is a circuit diagram illustrating a configuration of the electrical-discharge-machining-pulse generating units 4a to 4j of the electrical discharge machining apparatus according to the first embodiment of the present invention. A capacitor 12 is charged from a DC power source 11 through a charging resistor 13 by disconnecting an electrical-discharge-machining-pulse applying switch 14. Next, the energy stored in the capacitor 12 is fed to the opposing sections 2a to 2j of the machining electrode 2 via the power feed contacts 9a to 9j by connecting the electrical-discharge-machining-pulse applying switch 14. The switch 14 can be composed of, for example, a transistor (including a field-effect transistor).

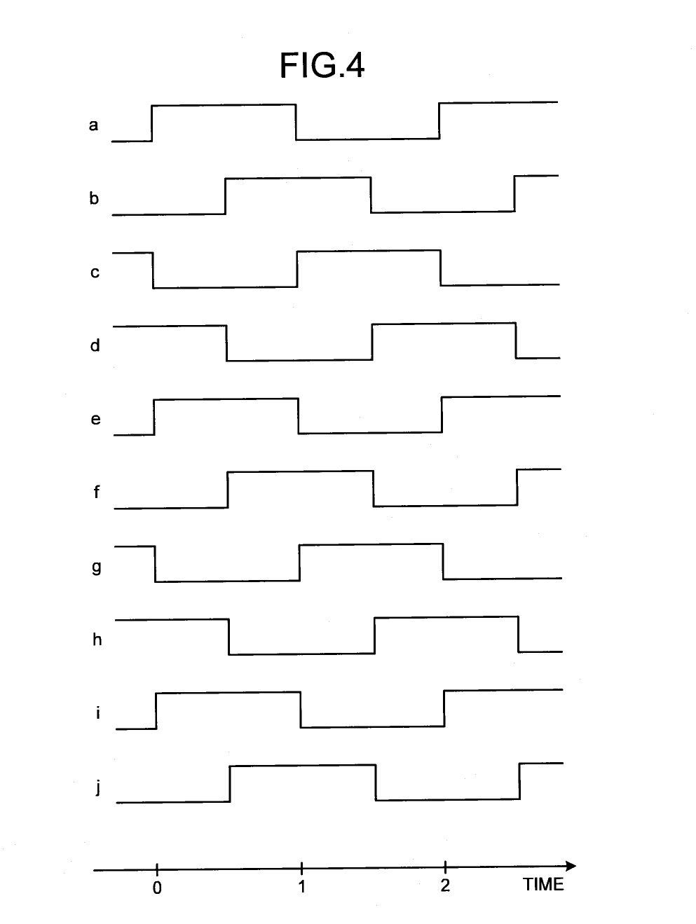

FIG. 4 is a diagram illustrating an electrical discharge machining pulse pattern of the electrical discharge machining apparatus according to the first embodiment of the present invention. The pulse control unit 5 instructs the pulse generating units 4a, 4e, and 4i to start applying an electrical discharge machining pulse at time 0, stop the application at time 1, and apply an electrical discharge machining pulse again at time 2.

Moreover, the pulse control unit 5 instructs the pulse generating units 4b, 4f, and 4j to start applying an electrical discharge machining pulse at time 0.5, stop the application at time 1.5, and apply an electrical discharge machining pulse again at time 2.5. Moreover, the pulse control unit 5 sends an instruction to the pulse generating units 4c and 4g to apply an electrical discharge machining pulse from time 1 to time 2 and an instruction to the pulse generating units 4d and 4h to apply an electrical discharge machining pulse from time 1.5 to time 2.5.

This means that, although there is a timing at which a voltage is applied to a plurality of the opposing sections of the pulse generating units 4a to 4j at the same time (for example, the opposing sections 2a, 2d, 2e, 2h, and 2i at time 0.25 in FIG. 4), the pulse control unit 5 controls the pulse generating units 4a to 4j to provide a difference so that the starting times for applying an electrical discharge machining pulse to adjacent opposing sections (for example, the opposing section 2a and the opposing section 2b) of the pulse generating units 4a to 4j do not coincide with each other.

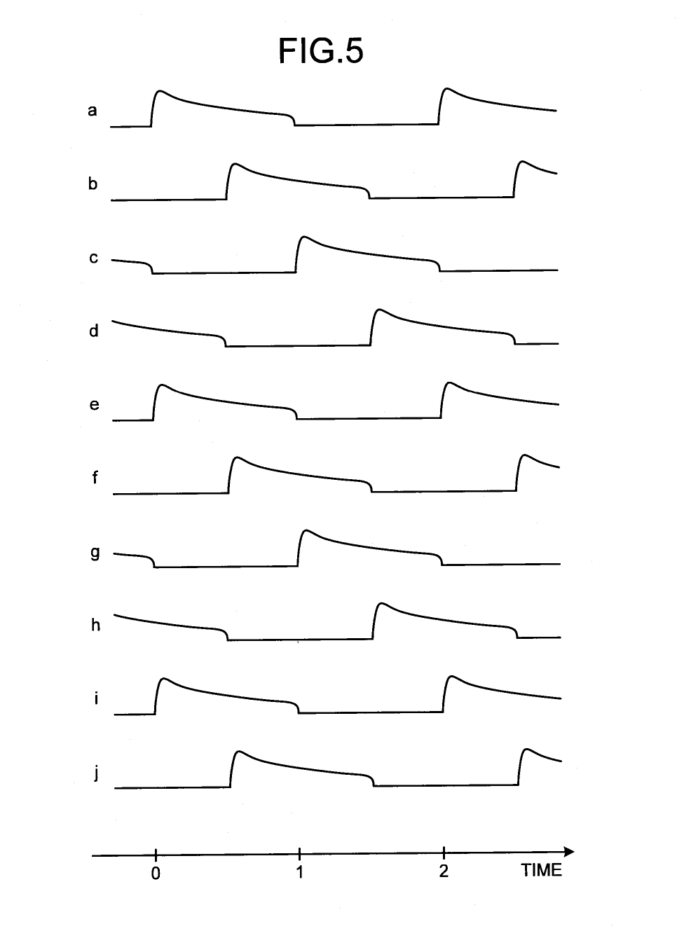

FIG. 5 illustrates waveforms of current flowing in the opposing sections 2a, 2b, 2c, 2d, 2e, 2f, 2g, 2h, 2i, and 2j of the machining electrode 2 when the distance between the workpiece 1 and each of the opposing sections 2a, 2b, 2c, 2d, 2e, 2f, 2g, 2h, 2i, and 2j of the machining electrode 2 is the distance (for example, a few to tens of micrometers) at which a normal discharge is generated in the first embodiment of the present invention.

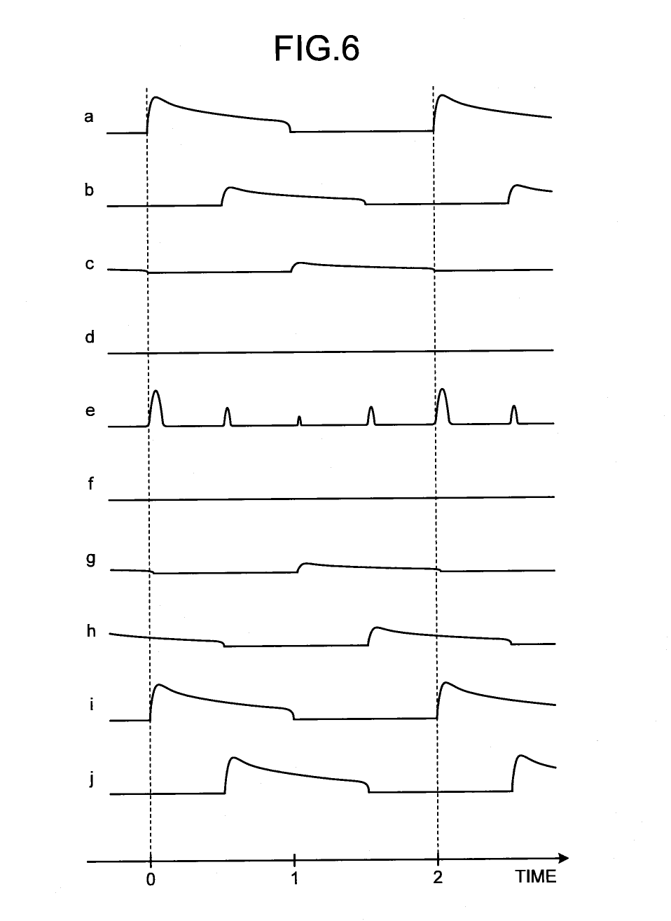

FIG. 6 illustrates current waveforms when the workpiece 1 and the opposing section 2e of the machining electrode 2 are in contact with each other and the distance between the workpiece 1 and each of the other opposing sections 2a, 2b, 2c, 2d, 2f, 2g, 2h, 2i, and 2j of the machining electrode 2 is the distance at which a normal electrical discharge is generated in the first embodiment of the present invention. The peak machining current due to the machining pulse appears in the opposing section 2e between times 0 and 0.1 and times 2 and 2.1, and this is substantially the same as a case of applying a similar electrical discharge machining pulse to an electrical discharge machining apparatus in which there is one opposing section of the machining electrode with respect to the workpiece and the machining electrode is electrically in contact with the workpiece.

According to the present embodiment, power feeding is not started simultaneously to the opposing section 2e of the machining electrode that is in contact with the workpiece 1 and the opposing sections 2d and 2f adjacent to the opposing section 2e. Therefore, in a time period during which the peak current occurs, the impedance from the opposing section to the closest opposing section to which power feeding is started simultaneously increases by four times as much as the case of starting power feeding simultaneously to all the opposing sections of the machining electrode 2. Therefore, even when a short circuit occurs, the energy caused by electrical discharge machining pulses fed to the other opposing sections flowing into a short-circuited portion through the machining electrode can be suppressed considerably.

As a result, it is possible to provide a high-speed electrical discharge machining apparatus that generates electrical discharge at a plurality of locations at the same time while avoiding disconnection of the machining electrode and degradation of the quality of the machined surface. Moreover, the machining electrode 2 is supplied from one machining electrode bobbin 8 and there are only guide rollers 7a to 7d between the mutually adjacent opposing sections of the machining electrode, therefore, multiple parallel (for example, 10 or more) and narrowed gap (for example, 1 mm or less) can be easily realized.

Furthermore, it becomes possible to control pulses in the electrical discharge machining at the same time in the adjacent opposing sections 2a to 2j at a plurality of locations regardless of whether it is the time for which an electrical discharge machining pulse is applied or the time for which an electrical discharge machining pulse is paused, therefore, it is possible to provide a high-speed electrical discharge machining apparatus that generates a discharge in a plurality of non-adjacent opposing sections at the same time while suppressing energy flowing through the machining electrode 2 without reducing the discharge frequency.

Moreover, because the path of the machining electrode 2 does not need to be made long between each of the opposing sections 2a to 2j of the machining electrode 2, the apparatus can be reduced in size. Furthermore, because it is sufficient to wind the machining electrode around each of the guide rollers 7a to 7d only once in order, the preparation process before the starting of the machining can be shortened.

In the present embodiment, an example is given where the machining electrode 2 and the workpiece 1 are opposed to each other at ten locations, however, a similar effect can be obtained even with an electrical discharge machining apparatus that includes a machining electrode opposed to the workpiece at M locations (M is 2 or larger). The effect becomes greater as M becomes larger. Moreover, in the present embodiment, an equal difference is provided between the application start times of an electrical discharge machining pulse to be applied to adjacent opposing sections of the machining electrode, however, a similar effect can be obtained even if the difference is not uniform as long as the difference is made equal to or longer than the peak time (for example, 0.1 μsec) of current is provided.

Particularly, the electrical discharge machining apparatus according to the present embodiment can avoid abnormal consumption and disconnection of the machining electrode and degradation of the quality of the machined surface by suppressing the concentration of the electrical discharge machining current, which flows largely immediately after the start of the application of an electrical discharge machining pulse, in a short-circuit portion. Moreover, abnormal consumption and disconnection of the machining electrode and degradation of the quality of the machined surface can be avoided while maintaining the machining speed regardless of the rate of the application time or the pause time of electrical discharge machining pulses. Moreover, because the gaps can be narrowed, the apparatus can be reduced in size. Furthermore, the preparation process before the start of the machining can be shortened.

Moreover, the electrical discharge machining apparatus according to the present embodiment is particularly useful in a case where a large machining current flows immediately after the start of the application of an electrical discharge machining pulse, as in a system in which an electrical discharge machining pulse is applied between the workpiece and the machining electrode by electrically connecting a capacitor in which charge has been stored in advance to the workpiece and the machining electrode.

In the present embodiment, one machining electrode 2 is caused to oppose the workpiece 1 at the opposing sections 2a to 2j at a plurality of locations. However, even when each of a plurality of machining electrodes, which are electrically insulated from each other, is opposed to the workpiece in deionized water, if the intervals between the machining electrodes are narrowed (for example, 1 mm or less) and the machining electrodes are made parallel to each other over a long distance (for example, 150 mm or more), the resistance between opposing sections of adjacent machining electrodes becomes about a few hundred ohms or less, therefore, an effect similar to the present embodiment can be obtained.

### Second Embodiment

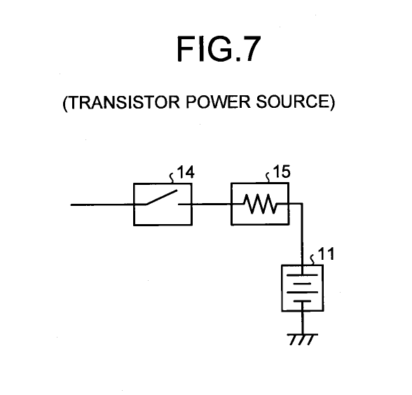

A schematic diagram of the main part of an electrical discharge machining apparatus according to the second embodiment of the present invention is illustrated in FIG. 1 in a similar manner to the first embodiment. FIG. 7 is a circuit diagram illustrating a configuration of the electrical-discharge-machining-pulse generating units 4a to 4j of the electrical discharge machining apparatus according to the second embodiment of the present invention. The energy supplied from the DC power source 11 is limited by a current-limiting resistor 15 by connecting the electrical-discharge-machining-pulse applying switch 14 and is fed to the opposing sections 2a to 2j of the machining electrode 2 via the power feed contacts 9a to 9j. The electrical-discharge-machining-pulse applying switch 14 can be composed of, for example, a transistor (including a field-effect transistor).

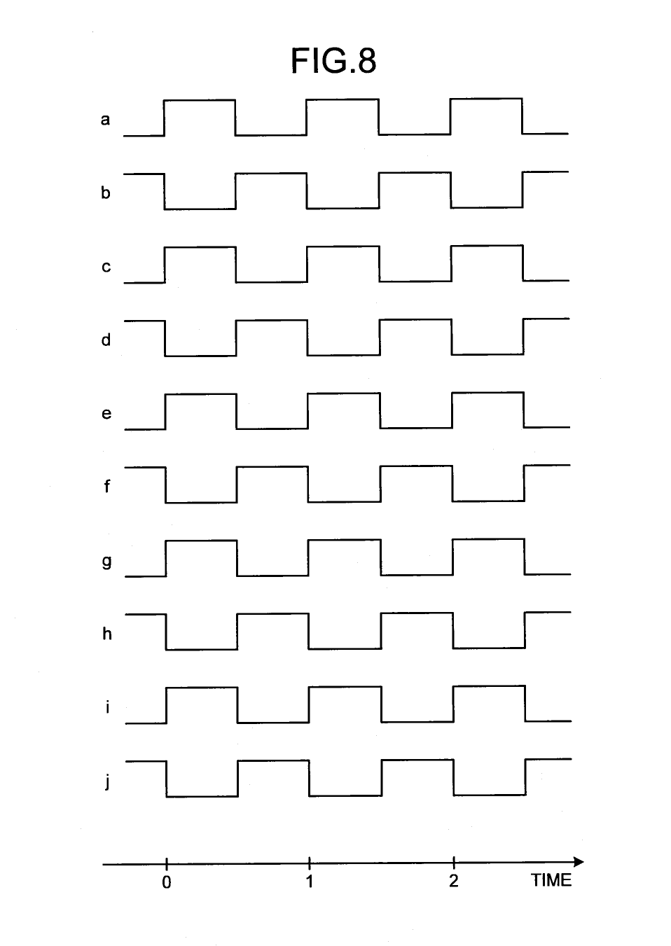

FIG. 8 is a diagram illustrating an electrical discharge machining pulse pattern of the electrical discharge machining apparatus according to the present embodiment. The pulse control unit 5 instructs the pulse generating units 4a, 4c, 4e, 4g, and 4i to start applying an electrical discharge machining pulse at time 0, stop the application at time 0.5, start applying an electrical discharge machining pulse at time 1, stop the application at time 1.5, start applying an electrical discharge machining pulse at time 2, and stop the application at time 2.5. Moreover, the pulse control unit 5 instructs the pulse generating units 4b, 4d, 4f, 4h, and 4j to apply an electrical discharge machining pulse from time 0.5 to time 1.0, time 1.5 to time 2.0, and time 2.5 to time 3.0.

In this manner, the pulse control unit 5 according to the present embodiment does not apply an electrical discharge machining pulse to adjacent opposing sections (for example, the opposing section 2a and the opposing section 2b) at the same time, i.e., the pulse control unit 5 controls the pulse generating units 4a to 4j so as not to provide a time period during which an electrical discharge machining pulse is applied to adjacent opposing sections at the same time.

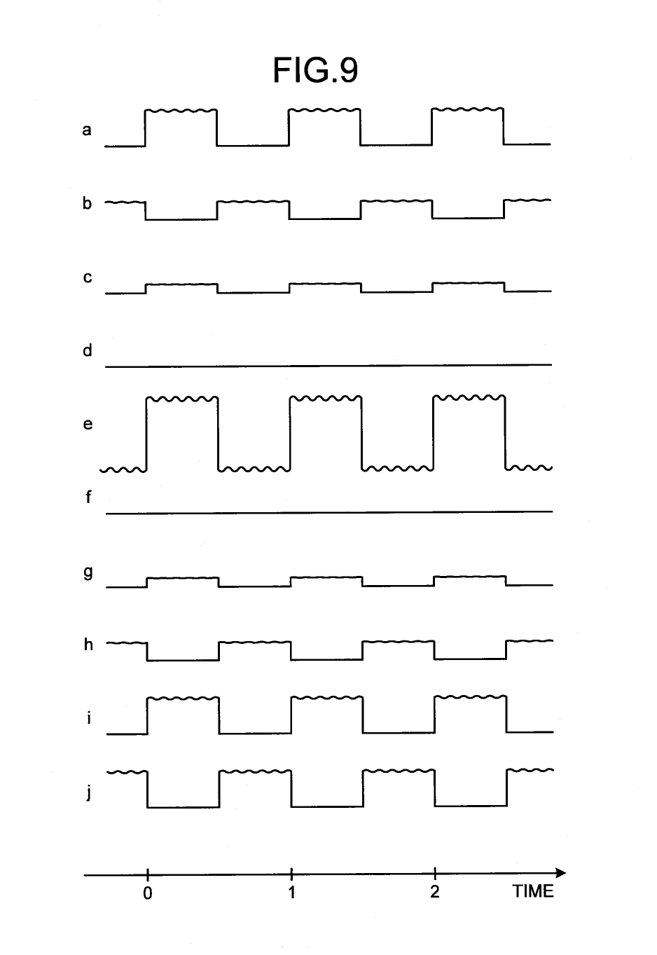

FIG. 9 illustrates current waveforms when the workpiece 1 and the opposing section 2e of the machining electrode 2 are in contact with each other and the workpiece 1 and the other opposing sections of the machining electrode 2 are not in contact with each other in the second embodiment. According to the present embodiment, power feeding is not performed to the opposing sections 2d and 2f, which are adjacent to the opposing section 2e, at the same time. Therefore, the impedance from the opposing section to the closest opposing section to which power feeding is started simultaneously increases by twice as much as the case of starting power feeding simultaneously to all the opposing sections of the machining electrode 2. Therefore, even when a short circuit occurs, the energy caused by electrical discharge machining pulses fed to the other opposing sections flowing into a short-circuit portion through the machining electrode can be suppressed considerably.

As a result, it is possible to provide a high-speed electrical discharge machining apparatus that generates electrical discharge at a plurality of locations at the same time while avoiding disconnection of the machining electrode and degradation of the quality of the machined surface. Moreover, the machining electrode 2 is supplied from one machining electrode bobbin 8 and there are only guide rollers 7a to 7d between the mutually adjacent opposing sections of the machining electrode, therefore, multiple parallel (for example, 10 or more) and narrowed gap (for example, 1 mm or less) can be easily realized.

Moreover, because the path of the machining electrode 2 does not need to be made long between each of the adjacent opposing sections 2a to 2j of the machining electrode 2, the apparatus can be reduced in size. Furthermore, because it is sufficient to wind the machining electrode around each of the guide rollers 7a to 7d only once in order, the preparation process before the starting of the machining can be shortened.

In the present embodiment, an example is given where the machining electrode 2 and the workpiece 1 are opposed to each other at ten locations, however, a similar effect can be obtained even with an electrical discharge machining apparatus that includes a machining electrode opposed to the workpiece at M locations (M is 2 or larger). The effect becomes greater as M becomes larger. Moreover, in the present embodiment, an equal difference is provided between the application start times of an electrical discharge machining pulse to be applied to adjacent opposing sections of the machining electrode, however, a similar effect can be obtained even if the difference is not uniform as long as the electrical discharge machining pulse is not applied to adjacent opposing sections at the same time.

In the electrical discharge machining apparatus according to the present embodiment, no electrical discharge machining pulse is applied to an adjacent machining electrode, therefore, this is equivalent to the fact that the impedance between machining electrodes opposed to the workpiece increases by at least twice or more and thus it is possible to prevent abnormal consumption and disconnection of the machining electrode and degradation of the quality of the machined surface. Moreover, because the gaps can be narrowed, the electrical discharge machining apparatus can be reduced in size. Furthermore, the preparation process before the start of the machining can be shortened. The electrical discharge machining apparatus according to the present embodiment is particularly useful in the case of using a pulse generating unit that uses a resistor and a transistor (including a field-effect transistor) and applies rectangular electrical discharge machining pulses.

In the present embodiment, one machining electrode 2 is caused to oppose the workpiece 1 at the opposing sections 2a to 2j at a plurality of locations. However, even when each of a plurality of machining electrodes is opposed to the workpiece in deionized water, if the intervals between the machining electrodes are narrowed (for example, 1 mm or less) and the machining electrodes are made parallel to each other over a long distance (for example, 150 mm or more), the resistance between opposing sections of adjacent machining electrodes becomes about a few hundred ohms or less, therefore, an effect similar to the present embodiment can be obtained.

### Third Embodiment

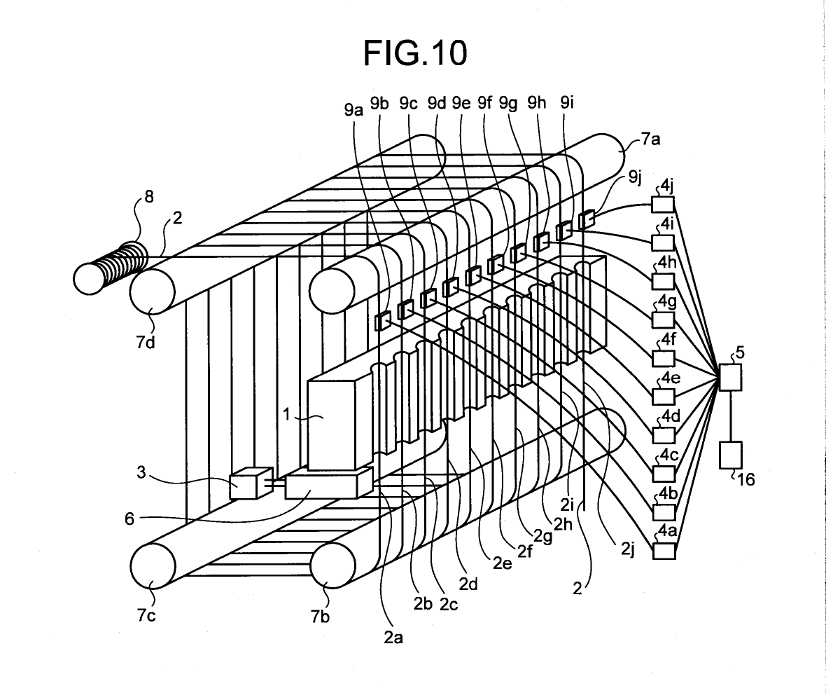

FIG. 10 is a schematic diagram of the main part of an electrical discharge machining apparatus according to the third embodiment of the present invention. In addition to FIG. 1, a pulse pattern storing unit 16 is further included.

The pulse generating units 4a to 4j are divided into groups, each including, for example, five pulse generating units in the order starting with the pulse generating unit 4a, and the pulse pattern storing unit 16 stores therein the order of applying an electrical discharge machining pulse in each group. Specifically, for example, the following order pattern is stored.

First→Third→Fifth→Second→Fourth→(thereafter, repeat from the First)

The pulse control unit 5 that has read the order of an electrical discharge machining pulse from the pulse pattern storing unit 16 instructs the pulse generating units 4a, 4b, 4c, 4d, and 4e to start applying an electrical discharge machining pulse in the following order.

4a→4c→4e→4b→4d→(return to 4a)

In a similar manner, the pulse control unit 5 instructs the pulse generating units 4f, 4g, 4h, 4i, and 4j to start applying an electrical discharge machining pulse in the following order.

4f→4h→4j→4g→4i→(return to 4f)

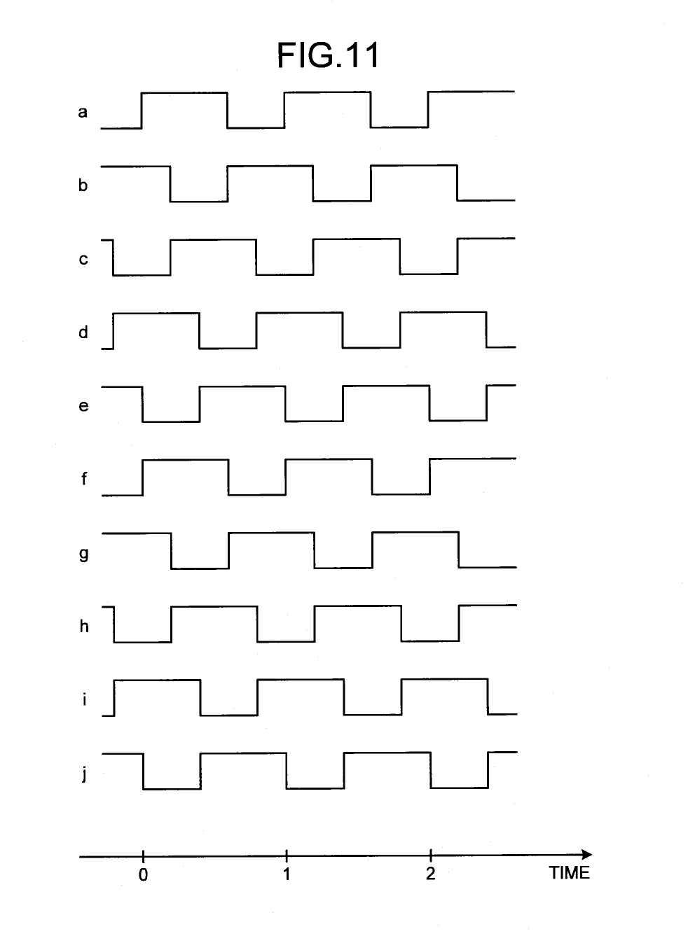

FIG. 11 is a diagram illustrating an electrical discharge machining pulse pattern of the electrical discharge machining apparatus according to the present embodiment. The pulse control unit 5 instructs the pulse generating units 4a and 4f to start applying an electrical discharge machining pulse at time 0, stop the application at time 0.6, and apply an electrical discharge machining pulse again between times 1 and 1.6.

Moreover, the pulse control unit 5 instructs the pulse generating units 4b and 4g to apply an electrical discharge machining pulse between times 0.6 and 1.2 and times 1.6 and 2.2, instructs the pulse generating units 4c and 4h to apply an electrical discharge machining pulse between times 0.2 and 0.8 and times 1.2 and 1.8, instructs the pulse generating units 4d and 4i to apply an electrical discharge machining pulse between times 0.8 and 1.4 and times 1.8 and 2.4, and instructs the pulse generating units 4e and 4j to apply an electrical discharge machining pulse between times 0.4 and 1.0 and times 1.4 and 2.0.

According to the present embodiment, it is possible to store the appropriate order of starting the application of electrical discharge machining pulses to increase the difference between the application start times of an electrical discharge machining pulse for adjacent opposing sections of the machining electrode 2, therefore, the effect of electrical discharge machining pulses applied to the other opposing sections of the machining electrode 2 can be eliminated. Consequently, it becomes possible to provide a high-speed electrical discharge machining apparatus that generates electrical discharges at a plurality of locations at the same time while preventing abnormal consumption and disconnection of the machining electrode and degradation of the quality of the machined surface.

### Fourth Embodiment

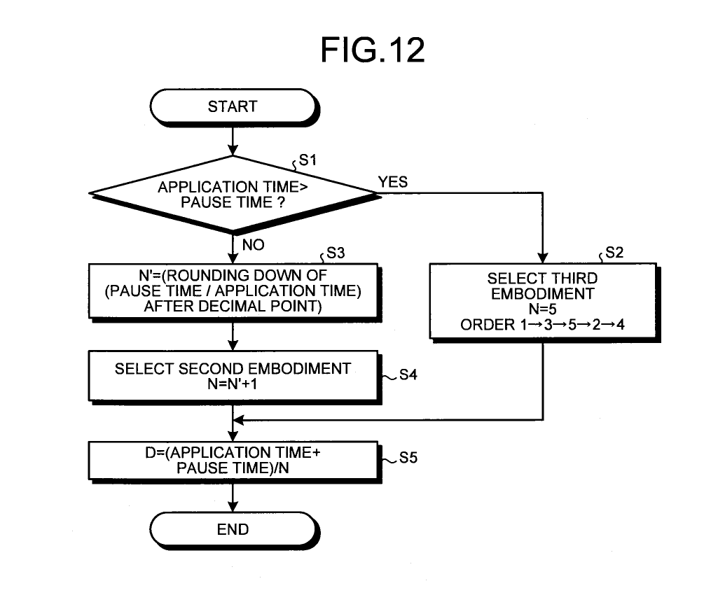

FIG. 12 is a flowchart for determining an electrical discharge machining pulse pattern of an electrical discharge machining apparatus according to the fourth embodiment of the present invention. This flowchart is performed, for example, by the pulse control unit 5. First, the application time and the pause time of electrical discharge machining pulses are compared (Step S1).

If the application time is longer, five adjacently arranged opposing sections are controlled so that the application of electrical discharge machining pulses is not started simultaneously in a similar manner to the third embodiment. If the unit of the number of the opposing sections, for which the application of electrical discharge machining pulses is not started simultaneously, is defined as N, then N is five.

Then, the application of electrical discharge machining pulses is started in the following order (Step S2) while providing a difference D that is one fifth of the sum of the application time and the pause time (Step S5) in the groups, each including five pulse generating units, in a similar manner to the third embodiment.

First→Third→Fifth Second→Fourth→(thereafter, repeat from the First)

As described above, in Step S5, a minimum interval D of the difference between the application start times of each electrical discharge machining pulse for different opposing sections when the application start times do not coincide with each other is determined by the following equation.

D=(application time+pause time)/N

On the other hand, in Step S1, when it is determined that the application time of an electrical discharge machining pulse is equal to or shorter than the pause time, N′ is calculated, which is given by (rounding down of (pause time/application time) after the decimal point) (Step S3). Then, N is defined as N′+1 and the second embodiment is selected (Step S4). When N=2, D=(application time+pause time)/2 in Step S5, therefore, the application of electrical discharge machining pulses for adjacent opposing sections of the machining electrode is started while providing a difference that is a half of the sum of the application time and the pause time in a similar manner to the second embodiment.

As described above, in the present embodiment, for example, the pulse control unit 5 determines the number N of continuously adjacent opposing sections of the machining electrode 2 whose application start times of an electrical discharge machining pulse do not coincide with each other, the minimum interval D of the difference between the application start times of an electrical discharge machining pulse when the application start times do not coincide with each other, and a pattern of the order of applying an electrical discharge machining pulse by the pulse generating units on the basis of the application time and the pause time of a given electrical discharge machining pulse pattern.

Moreover, the third embodiment selected in Step S1 is not limited to a case where N=5 and the embodiment selected in Step S1 is not limited to the above. Accordingly, it is obvious that various variations can be considered with respect to the present embodiment including changes in the pattern of electrical discharge machining pulses without being limited to the above embodiment.

According to the present embodiment, a pulse generation pattern can be controlled in accordance with discharge energy and an oscillation frequency, therefore, abnormal consumption and disconnection of the machining electrode and degradation of the quality of the machined surface can be prevented by preventing discharge energy from flowing from an adjacent opposing section of the machining electrode. Because a user does not need to examine and set a pulse generation pattern, an unskilled person can easily perform the machining and the automation.

Furthermore, the present invention is not limited to the above-described embodiments and various modifications can be made in the execution phase without departing from the scope of the invention. Moreover, in the embodiments described above, inventions in various phases are included, therefore, various inventions can be extracted by an appropriate combination of a plurality of disclosed components. For example, even when some components are removed from all the components illustrated in the embodiments, if the problems described in the Technical Problem section can be solved and the advantages described in the Advantageous Effects of Invention section can be obtained, then the configuration without the removed components can be extracted as an invention. Furthermore, components in different embodiments may be appropriately combined.

### INDUSTRIAL APPLICABILITY

As described above, the electrical discharge machining apparatus and the electrical discharge machining method according to the present invention are useful in a system in which an electrical discharge machining pulse is applied between a workpiece and a machining electrode by electrically connecting a capacitor, in which electrical charge is stored in advance, to the workpiece and the machining electrode, and is particularly suitable to a case where large machining current flows immediately after the start of the application of an electrical discharge machining pulse.

### REFERENCE SIGNS LIST

1 WORKPIECE
2 MACHINING ELECTRODE
2a, . . . , 2j OPPOSING SECTION OF MACHINING ELECTRODE OPPOSED TO WORKPIECE
3 TABLE DRIVING MOTOR
4a, . . . , 4j PULSE GENERATING UNIT
5 PULSE CONTROL UNIT
6 DRIVING TABLE
7a, 7b, 7c, 7d GUIDE ROLLER
8 MACHINING ELECTRODE BOBBIN
9a, . . . , 9j POWER FEED CONTACT
10a, . . . , 10i EQUIVALENT RESISTANCE BETWEEN ADJACENT OPPOSING SECTIONS OF MACHINING ELECTRODE
11 DC POWER SOURCE
12 CAPACITOR
13 CHARGING RESISTOR
14 ELECTRICAL-DISCHARGE-MACHINING-PULSE APPLYING SWITCH
15 CURRENT-LIMITING RESISTOR
16 PULSE PATTERN STORING UNIT

1. An electrical discharge machining apparatus comprising:
a machining electrode that is one wire and includes a plurality of opposing sections with respect to a workpiece by being wound around a plurality of guide rollers;
a driving unit that changes a relative distance between the workpiece and the opposing sections; and
a plurality of pulse generating units that apply electrical discharge machining pulses between the workpiece and the opposing sections, respectively, wherein
the pulse generating units are controlled such that application start times of electrical discharge machining pulses for adjacent opposing sections do not coincide with each other.

2. The electrical discharge machining apparatus according to claim 1, wherein the pulse generating units are controlled such that no electrical discharge machining pulse is applied to adjacent opposing sections at the same time.

3. The electrical discharge machining apparatus according to claim 1, further comprising a storing unit that stores information on an order of applying electrical discharge machining pulses by the pulse generating units, wherein
the order of applying electrical discharge machining pulses by the pulse generating units is controlled based on the information.

4. The electrical discharge machining apparatus according to claim 1, wherein the pulse generating units are controlled by defining the number of continuously adjacent opposing sections whose application start times of electrical discharge machining pulses are different from each other, a minimum interval D of a difference between application start times of electrical discharge machining pulses when the application start times are different from each other, and an order of applying an electrical discharge machining pulse, based on an application time and a pause time of an electrical discharge machining pulse pattern.

5. An electrical discharge machining method comprising:
using a machining electrode that is one wire and includes a plurality of opposing sections with respect to a workpiece by being wound around a plurality of guide rollers;
changing a relative distance between the workpiece and the opposing sections;
individually applying an electrical discharge machining pulses between the workpiece and each of the opposing sections; and
controlling such that application start times of electrical discharge machining pulses for adjacent opposing sections do not coincide with each other.

6. The electrical discharge machining method according to claim 5, further comprising controlling such that no electrical discharge machining pulse is applied to adjacent opposing sections at the same time.

7. The electrical discharge machining method according to claim 5, further comprising:
storing information on an order of applying electrical discharge machining pulses; and
controlling the order of applying electrical discharge machining pulses based on the information.

8. The electrical discharge machining method according to claim 5, further comprising controlling a plurality of the pulse generating units by defining number of continuously adjacent opposing sections whose application start times of electrical discharge machining pulses are different from each other, a minimum interval D of a difference between application start times of electrical discharge machining pulses when the application start times are different from each other, and an order of applying electrical discharge machining pulses, based on an application time and a pause time of an electrical discharge machining pulse pattern.
